(19) United States
(12) Patent Application Publication
(10) Pub. No.: US 2015/0100284 A1
(43) Pub. Date: Apr. 9, 2015

(54) Metrics and Semiparametric Model Estimating Failure Rate and Mean time Between Failures

(71) Applicant: The Trustees of Columbia University in the City of New York, New York, NY (US)

(72) Inventors: Timothy Teravainen, New York, NY (US); Leon L. Wu, New York, NY (US); Roger N. Anderson, New York, NY (US); Albert Boulanger, New York, NY (US)

(21) Appl. No.: 14/047,879

(22) Filed: Oct. 7, 2013

(51) Int. Cl. G06F 17/50

(52) U.S. Cl. CPC G06F 17/5009
USPC 703/2

(57) ABSTRACT

Techniques for predicting a failure metric of a physical system using a semiparametric model, including providing raw data representative of the physical system, to identify a set of units at risk in the physical system, a set of times of treatment corresponding to a event of at least one unit in the set of units, and an index-set of the at least one unit for which a event has occurred. A parametric and a nonparametric component of the semiparametric model are estimated and a hazard rate is predicted at a given time with the semiparametric model.

### CROSS-REFERENCE TO RELATED APPLICATIONS

This application is related to U.S. Provisional Application Ser. No. 61/475,477, filed Apr. 14, 2011, which is incorporated herein by reference in its entirety and from which priority is claimed.

### STATEMENT REGARDING FEDERALLY SPONSORED RESEARCH OR DEVELOPMENT

This invention was made with government support under grant No. OE-OE0000197, awarded by the Department of Energy. The government has certain rights in the invention.

### BACKGROUND

The presently disclosed subject matter relates to systems and methods for predicting a failure metric by employing a semiparametric model, and more particularly to systems and methods for predicting a failure metric in a physical system, such as an electrical grid, using a semiparametric model.

Power utilities generate electrical power at remote plants and deliver electricity to residential, business or industrial customers via transmission networks and distribution grids. Power is first transmitted as high voltage transmissions from the remote power plants to geographically diverse substations. From the substations, the received power can be sent using cables or “feeders” to local transformers that further reduce the voltage. The outputs of the transformers can be connected to a local low voltage power distribution grid that can be tapped directly by the customers, such as in dense urban environments. The power distribution grids can be configured as either radial or networked systems. A radial distribution system can include a number of feeder circuits that extend radially from a substation. Each circuit serves customers within a particular area and the failure of a radial circuit cuts off electric service to the customers on that circuit.

In a networked distribution system, service can be provided through multiple paths (e.g., through multiple transformers) connected in parallel, as opposed to the radial system in which there can be only one path for power to flow from the substation to a particular load. A networked distribution system provides multiple potential paths through which electricity can flow to a particular load. By its nature, a networked distribution system can be more reliable than a radial distribution system. When a networked distribution system is properly designed and maintained, the loss of any single low or high voltage component usually does not cause an interruption in service or degradation of power quality. Network protection devices or switches can automatically operate to isolate the failed component. Networked distribution systems are installed in high-load density metropolitan areas (e.g., Chicago and New York City) that require reliable electricity service.

FIG. 1 shows a conventional infrastructure 100 associated with delivering electrical power to residential, business, or industrial customers. Infrastructure 100 can be viewed as having four primary sections, namely, generation 110, transmission 120, primary distribution 130, and secondary distribution 140. Generation 110 involves a prime mover, which spins an electromagnet, generating large amounts of electrical current at a power plant or generating station. Transmission 120 involves sending the electrical current at very high voltage (e.g., at hundreds of kV) from the generating station to substations closer to the customer. Primary distribution 130 involves sending electricity at mid-level voltage (e.g., at tens of kV) from substations to local transformers over cables (feeders). Each of the feeders, which can be up to 10-20 km long (e.g., as in the case of Consolidated Edison Company of New York, Inc.'s (“Con Ed”) distribution system in New York City), supplies electricity to a few tens of local transformers. Each feeder can include many feeder sections connected by joints and splices. Secondary distribution 140 involves sending electricity at nominal household voltages from local transformers to individual customers over radial or networked feeder connections.

In metropolitan areas (e.g., New York City), the feeders can run under city streets, and can be spliced together in manholes. Multiple or redundant feeders can feed through transformers the customer-tapped secondary grid, so that individual feeders can fail without causing power outages. For example, the electrical distribution grid of New York City is organized into networks, each composed of a substation, its attached primary feeders, and a secondary grid. The networks are electrically isolated from each other to limit the cascading of problems or disturbances. Network protection switches on the secondary side of network transformers can be used for isolation, as well as protect against overloads and prevent back feeds. Isolation switches can be installed on the primary network. The primary feeders are critical and have a failure rate (i.e., a mean time between failures of less than 400 days). Therefore, much of the daily work of the power company's field workforce involves the monitoring and maintenance of primary feeders, as well as their speedy repair on failure.

Multiple or redundant feeders can feed the customer-tapped grid, so that individual feeders can fail without, causing power outages. The underground distribution network effectively forms at least a 3-edge connected graph, often referred to as a 2^{nd} contingency design—in other words, any two components can fail without disrupting delivery of electricity to customers. Many feeder failures result in automatic isolation—so called “Open Autos” or O/As. When an O/A occurs, the load that had been carried by the failed feeder must shift to adjacent feeders, further stressing them. O/As put networks, control centers, and field crews under considerable stress, especially during the summer, and cost millions of dollars in operations and maintenance expenses annually.

Providing reliable electric supply can require active or continuous “control room” management of the distribution system by utility operators. Real-time response to a disturbance or problem can, for example, require redirecting power flows for load balancing or sectionalizing as needed. The control room operators constantly monitor the distribution system for potential problems that could lead to disturbances. Sensors can be used to monitor the electrical characteristics (e.g., voltage, current, frequency, harmonics, etc.) and the condition of critical components (e.g., transformers, feeders, secondary mains, and circuit breakers, etc.) in the distribution system. The sensor data can guide empirical tactics (e.g., load redistribution in summer heat waves) or strategies (e.g., scheduling network upgrades at times of low power demand in the winter); and provide indications of unique or peculiar component life expectancy based on observations of unique or peculiar loads. In addition to sensor data, attribute data about the components that make up the feeders, such as type, manufacturer, specification code, and installation data, as well as electrical characteristics including the relationship to other feeders, is also available.

Power companies and utilities have developed models for evaluating the danger that a particular feeder or other network component could fail. The models, which can be based on traditional statistical techniques such as linear regression analysis, can provide likelihood of network failure or scores, which can be in-turn used to prioritize component and feeder testing (e.g., high voltage insulation testing or high potential testing (“Hipot testing”)), network repairs, maintenance or reinforcement. However, in practice, the scores in some cases provide only a rough indication of likely failure events.

Accordingly, there is a need for improved systems and methods for modeling and evaluating the likelihood of network failure.

### SUMMARY

In one aspect of the disclosed subject matter, a method for predicting a failure metric of a physical system using a semiparametric model includes providing a raw data assembly to provide raw data representative of the physical system. The raw data can be processed to identify a set of units at risk in the physical system, a set of times of treatment corresponding to a failure event of at least one unit in the set of units, and an index-set of the at least one unit for which a failure event has occurred. The set of units, set of times of treatment, and index-set can be stored in a memory. A parametric component of the semiparametric model can be estimated, and a nonparametric component of the semiparametric model can be estimated. A hazard rate can then predicted as a given time with the semiparametric model.

In one embodiment, the failure metric can comprise a mean time between failures. The physical system can be, for example, an electrical grid and the raw data assembly can be, for example, an outage database. Each treatment in the set of times of treatment can be a single “all-or-nothing” treatment occurring at a recorded time.

In one embodiment, the nonparametric component can be estimated as zero for all times except those included in the first set of times of treatment while estimating the parametric complement. The nonparametric component can then be estimated using a weighted nonparametric estimator using the estimate of the parametric component.

In one embodiment, the method can further comprise smoothing the nonparametric component with a smoothing process. For example, the smoothing process can be a Gaussian smoothing process.

In another aspect of the disclosed subject matter, a system for predicting a failure metric of a physical system using a semiparametric model includes a raw data assembly configured to provide raw data representative of the physical system. At least one processor is operatively configured to the raw data assembly for processing the raw data to identify a set of units at risk in the physical system, a set of times of treatment corresponding to a failure event of at least one unit in the set of units, and an index-set of the at least one unit for which a failure event has occurred. The system can include a memory, operatively coupled to the processor, for storing the set of units, the set of times of treatment, and the index-set. A parametric estimator can be configured to estimate a parametric component of the semiparametric model and a nonparametric estimator is configured to estimate a nonparametric component of the semiparametric model based on the set of units, the set of times of treatment, and the index-set. The system can also include at least one output for outputting a predicted hazard rate at a given time with the semiparametric model.

### BRIEF DESCRIPTION OF THE DRAWINGS

FIG. 1 is a schematic diagram illustrating the infrastructure associated with the generation, transmission and distribution of electricity to customers. The electrical distribution system can involve, for example, (1) power generation at 75 kilovolts (kV), (2) high voltage transmission at 325 kV to a sub-station at which the voltages are stepped down to 13, 27, or 33 kV, and (3) transmission of the stepped-down voltages over distribution feeders to local transformers, which (4) further convert the power to standard line voltages (i.e., 110, 220, or 440 volts) for delivery to consumers.

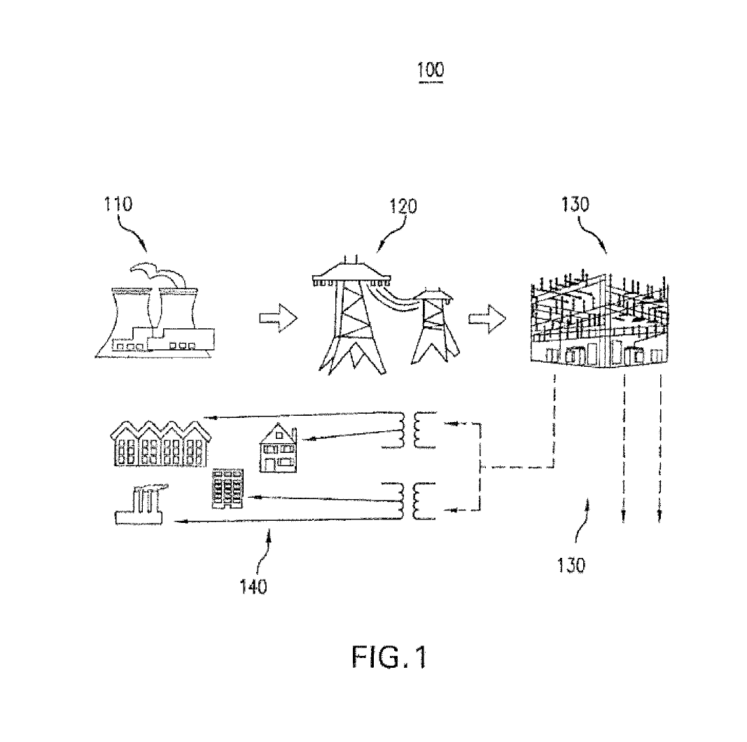

FIG. 2 is a flow diagram of a method for predicting a failure metric of a physical system according to one embodiment of the presently disclosed subject matter.

FIG. 3 is a schematic diagram of a system for predicting a failure metric of a physical system according to one embodiment of the presently disclosed subject matter.

FIG. 4 illustrates the results of the disclosed Example using the techniques of the disclosed subject matter without smoothing.

FIG. 5 illustrates the results of the disclosed Example using the techniques of the disclosed subject matter using a Gaussian process for smoothing.

FIG. 6 illustrates results of the disclosed Example using the techniques of the disclosed subject matter giving the estimated failure rate multiplier ψ(t) for each network.

### DETAILED DESCRIPTION

The presently disclosed subject matter relates to systems and methods for predicting a failure metric by employing a semiparametric model. Generally, a semiparametric model can have a parametric component and a nonparametric component. Each component can be estimated, and the components can be combined to achieve an accurate prediction of a failure rate. That is, a future failure rate can be estimated using the semiparametric model based on most recent failures. The techniques disclosed herein can provide accurate estimation based on historical data without the need for strong a priori assumptions of the failure rate pattern, and can be used for estimating reliability for many physical systems, such as an electrical grid.

As used herein, the term “treatment” refers to any prescribed combination of values of explanatory variables. For purpose of illustration and not limitation, a “treatment” can refer, in the context of an electrical grid, to the time of a previous outage due to the failure of a unit within the grid.

As used herein, the teini “blip treatment” refers to a single “all-or-nothing” treatment occurring at a recorded time. That is, a blip can be a short duration effect on a unit. For purpose of illustration and not limitation, a “blip treatment” can refer, in the context of an electrical grid, to a failure event of a unit or an electrical component within the grid at a recorded time. Additionally or alternatively, the event can be modeled or approximated with a Dirac delta function. For example, an open auto can be caused by a short duration electrical short (e.g., cut off by the protective relays at a substation). The event can be modeled with a Dirac delta function notwithstanding the fact that the outage itself, the time taken to isolate, repair, and reset the feeder can have a longer duration.

As used herein, the term “physical system” refers to any physical system in which failure rates can be modeled. For purpose of illustration and not limitation, the term “physical system” can refer to, for example, an electrical grid, a semiconductor chip, a collection automobile parts, a collection software and software components, a computer, a collection industrial equipment, or a cyber-physical system.

As used herein, the term “bathtub curve” refers to a hazard function which can be generally broken into three parts. The first part can be a decreasing failure rate, the second part can be relatively constant, and the third part can be an increasing failure rate, the curve thus resembling the shape of a bathtub.

As used herein, the term “infant mortality” refers to failures of a physical system that occur relatively early with reference to a hazard function. For example, “infant mortality” can refer to the first part of a “bathtub curve.”

As used herein, the term “mean time between failures” (MTBF) refers to the predicted elapsed time between inherent failures of a physical system during operation. For example, for constant repair rate distribution the MTBF can refer the sum of the operational periods divided by the number of observed failures. Additionally, the MTBF can refer to the expected value of a failure density function of time until failure.

A “parametric model,” as used herein, refers to a collection of distributions such that each member of the collection is described by a finite-dimensional parameter. By contrast, a “nonparametric model,” as used herein, refers to a model with a structure that is not defined a priori but is instead determined from data (i.e., the parameter need not be finite dimensional).

A semiparametric model, as referred to herein, can have a parametric component and a nonparametric component. That is, a semiparametric model can include a parametric component that is based on predetermined structure, and a nonparametric component that is based on observed data.

As noted above, evaluating system reliability of electrical grids has included estimating failure rate with historical failure information and/or testing of a current sample of the equipment. Cumulative distribution functions describing the probability of failure up to a time, t, can be used to estimate the failure rate. For example, the Weibull distribution can be used to estimate failure rates in an electrical grid.

The failure rate can be defined as the total number of failures within an item population, divided by the total time expended by that population, during a particular measurement interval under stated conditions. λ(t) denotes the failure rate at time t, and R(t) denotes the reliability function (also referred to as the survival function), which is the probability of no failure before time t. The failure rate is thus given by:

$$λ ( t ) = \frac{R ( t ) - R ( t + Δ t )}{Δ t \cdot R ( t )} . \qquad ( 1 )$$

As Δt tends to zero, λ becomes the instantaneous failure rate, which is also referred to the hazard function (or hazard rate) h(t):

$$h ( t ) = {lim}_{Δ t \to 0} \frac{R ( t ) - R ( t + Δ t )}{Δ t \cdot R ( t )} . \qquad ( 2 )$$

A failure distribution F(t) is a cumulative failure distribution function that describes the probability of failure up to and including time t:

F(t)=1−R(t),t≧0. (3)

For a system with a continuous failure rate, F(t) is the integral of the failure density function ƒ(t):

$$F ( t ) = {\int }_{0}^{t} f ( x ) d x . \qquad ( 4 )$$

The hazard function can thus be written as:

$$h ( t ) = \frac{f ( t )}{R ( t )} . \qquad ( 5 )$$

For the Weibull failure distribution, the failure density function ƒ(t) and cumulative failure distribution function F(t) are given by:

$$\begin{matrix}f ( t ; λ , k ) = \{ \begin{matrix}\frac{k}{λ} {( \frac{t}{λ} )}^{k - 1} {e}^{- {( t / λ )}^{k}} , & t \geq 0 \\ 0 , & t < 0\end{matrix} \\ and & ( 6 ) \\ F ( t ; λ , k ) = \{ \begin{matrix}1 - {e}^{- {( t / λ )}^{k}} & t \geq 0 \\ 0 , & t < 0\end{matrix} , & ( 7 )\end{matrix}$$

where k>0 is the shape parameter and λ>0 is the scale parameter of the distribution. The hazard function when t≧0 can thus be written as:

$$h ( t ; λ , k ) = \frac{k}{λ} {( \frac{t}{λ} )}^{k - 1} . \qquad ( 8 )$$

A value of k<1 indicates that the failure rate decreases over time. A value of k=1 indicates that the failure rate is constant over time. In this case, the Weibull distribution becomes an exponential distribution. A value of k>1 indicates that the failure rate increases over time.

The Weibull distribution can, in practice, provide only a rough estimate of failure rate. As described in more detail below, the systems and methods disclosed herein can provide a marked improvement in predicting failure rate relative the Weibull distribution. The disclosed subject matter can provide accurate estimation based on historical data without the need to make strong a priori assumptions of the failure rate pattern (e.g., constant or monotonic).

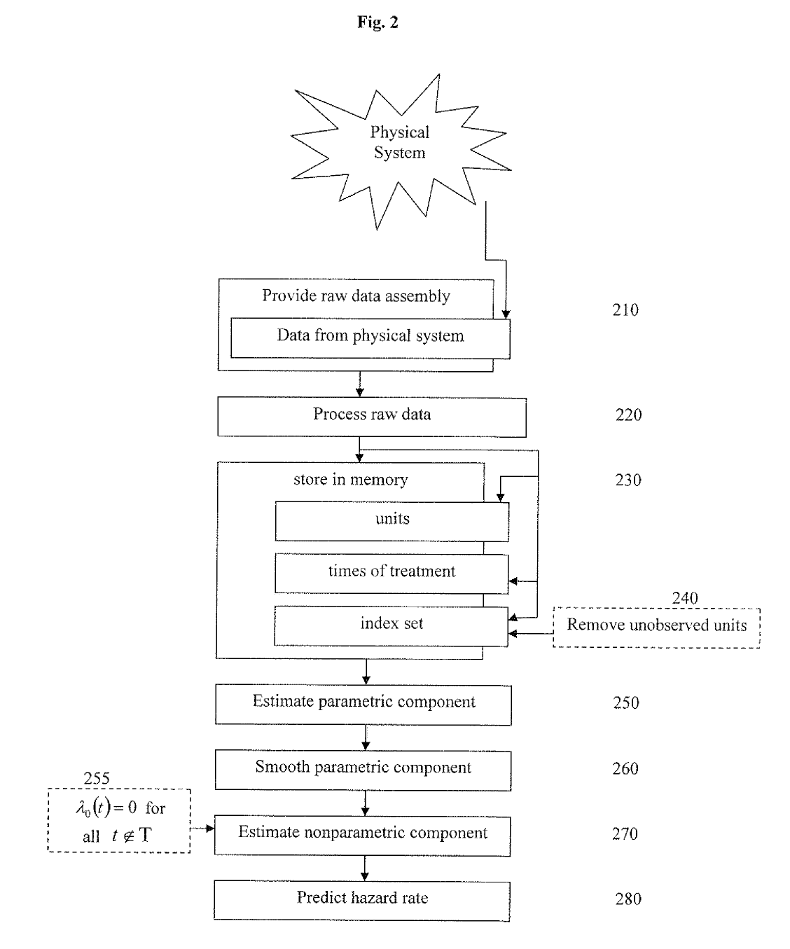

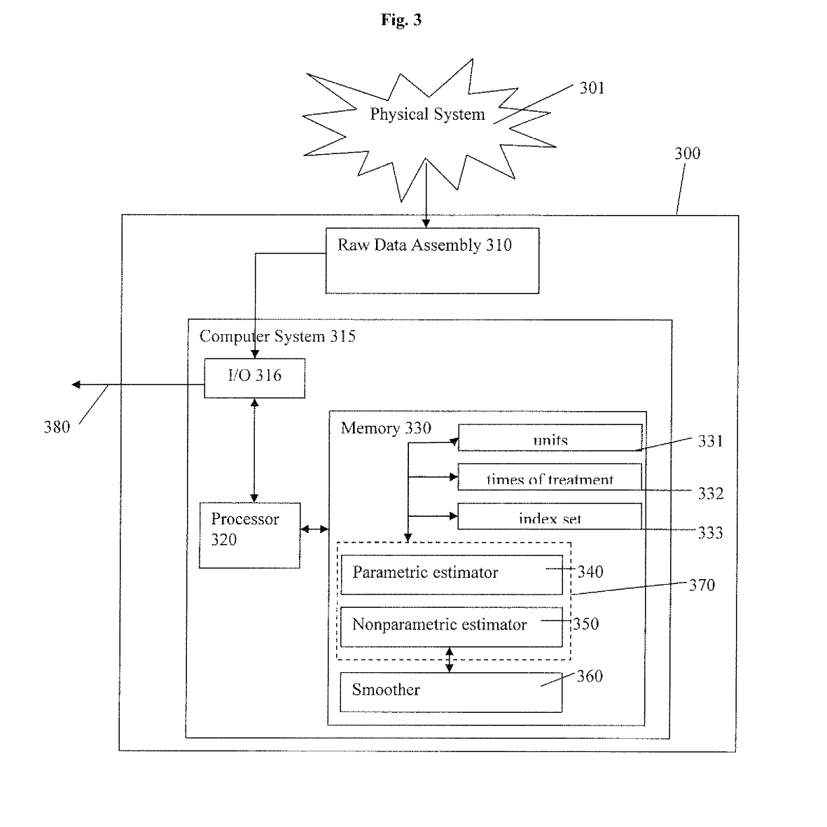

The presently disclosed subject matter relates to systems and methods for predicting a failure metric by employing a semiparametric model. Particular embodiments of the systems and methods are described below, with reference to FIG. 2 and FIG. 3. For purposes of illustration, and not limitation, the embodiments described below relate to predicting a failure metric of an electrical grid. However, the methods and systems described below can also be applied to other physical systems, as will be apparent to one of ordinary skill in the art. Additionally, for purposes of clarity the method and the system are described concurrently and in conjunction with each other.

In the following description, some embodiments of the present invention will be described in terms that can be implemented as software programs. Those skilled in the art will readily recognize that the equivalent of such software may also be constructed in hardware.

In one aspect of the disclosed subject matter, a method for predicting a failure metric of a physical system using a semiparametric model includes providing a raw data assembly to provide raw data representative of the physical system. The raw data can be processed to identify a set of units at risk in the physical system, a set of times of treatment corresponding to a failure event of at least one unit in the set of units, and an index-set of the at least one unit for which a failure event has occurred. The set of units, set of times of treatment, and index-set can be stored in a memory. A parametric component of the semiparametric model can be estimated, and a nonparametric component of the semiparametric model can be estimated. A hazard rate can then predicted as a given time with the semiparametric model.

In another aspect of the disclosed subject matter, a system for predicting a failure metric of a physical system using a semiparametric model includes a raw data assembly configured to provide raw data representative of the physical system. At least one processor is operatively configured to the raw data assembly for processing the raw data to identify a set of units at risk in the physical system, a set of times of treatment corresponding to a failure event of at least one unit in the set of units, and an index-set of the at least one unit for which a failure event has occurred. The system can include a memory, operatively coupled to the processor, for storing the set of units, the set of times of treatment, and the index-set. A parametric estimator can be configured to estimate a parametric component of the semiparametric model and a nonparametric estimator is configured to estimate a nonparametric component of the semiparametric model based on the set of units, the set of times of treatment, and the index-set. The system can also include at least one output for outputting a predicted hazard rate at a given time with the semiparametric model.

In one embodiment, and with reference to FIG. 2 and FIG. 3, a raw data assembly 310 is provided (210) to provide raw data representative of a physical system 301. The physical system 301 can be, for example, an electrical grid. In other embodiments, the physical system can be any system in which a failure rate of a unit within that system can be estimated, such as a semiconductor chip, a collection automobile parts, a collection software and software components, a computer, a collection industrial equipment, or a cyber-physical system.

The raw data assembly 310 can be, for example in the context of an electrical grid, an outage database that can be managed with a feeder management system (FMS) administered by one or more utility companies. The raw data can include historical information about units in the physical system, such as feeders in an electrical grid. This information can be provided from sensors or manually entered in the database by human operators. The data can contain information about, for example, the times of failure, model numbers, ages, and other characteristics of the units within the physical system 301. In some embodiments, raw data can be provided in real time. For example, as an outage database is updated with live data feed, it can be provided to the processor or estimator in real time or substantially real time so that up to date estimation can be processed. Additionally or alternatively, real time transformer status, oil temperatures, current and voltage readings from distribution transformers collected by a SCADA system, and/or real time data from partial discharge sensors on feeders or power quality sensors on feeders can also be used.

The raw data provided by the raw data assembly 310 can be processed (220) by a processor 320 to identify a set of units at risk in the physical system 331, a set of times of treatment 332 corresponding to a failure event of at least one unit in the set of units, and an index-set 333 of the at least one unit for which a failure event has occurred. The processor 320 can be operatively coupled to the raw data assembly. For example, the processor 320 can be part of a computer system 315 including an I/O device 316 for communicating with the processor 320. The processor 320 can include, but is not limited to, a programmable digital computer, a programmable microprocessor, a programmable logic processor, a series of electronic circuits, a series of electronic circuits reduced to the form of an integrated circuit, or a series of discrete components. In one embodiment, the processor 320 can be configured to receive raw data on-line. That is, the processor 320 can be configured to receive raw data, for example from an outage database, in real time. Additionally or alternatively, the processor 320 can be configured to receive data from remove supervisory control and data acquisition (SCADA) monitoring, including for example transformer electrical loads, data indicating that transformers may be offline (i.e., “Banks-Off”), or the like, in real time.

The set of units at risk 331, set of times of treatment 332, and index-set 333 can be stored (320) in a memory 330. The memory 330 can be operatively coupled to the processor 320 such that programs stored in the memory 330, when executed, can cause the processor 320 to perform a specified task. Additionally, the memory 330 can be operatively coupled to the processor 320 such that the processor can read and write to the memory 330. The memory 330 can be one or more suitably sized logical units of physical memory provided in semiconductor memory or magnetic memory, or the like. Memory of the disclosed system can store a computer program product having a program stored in a computer readable storage medium. Memory can include conventional memory devices including solid state, magnetic, optical or other data storage devices and can be fixed within system or can be removable. For example, memory can be an internal memory, such as, such as SDRAM or Flash EPROM memory, or alternately a removable memory, or a combination of both. Removable memory can be of any type, such as a Compact Flash (CF) or Secure Digital (SD) type card inserted into a socket and connected to the processor via a memory interface. Other types of storage that are utilized include without limitation PC-Cards, MultiMedia Cards (MMC), or embedded and/or removable hard drives.

The set of units at risk 331 in the physical system 310 can be a set of feeders under observation within an electrical grid. For example, if each of N feeders is under observation for some interval of time [0, T], the set of units at risk 331 would include each unit under observation within the interval of time [0, T].

The set of times of treatment 332 can be a set of times at which a failure event occurs. For example, if each of N feeders is under observation for some interval of time [0, T], the set of times of treatment 332 would include a finite set of times at which one of the N feeders experienced a failure event. That is, the time of treatment for a particular feeder corresponds to the time of a previous outage. In some embodiments, each treatment can be a single “all-or-nothing” treatment occurring at a recorded time. Such treatment can be referred to as a “blip treatment.” In some embodiments, values of the set of times of treatment 332 can be “binned” into percentiles.

The index-set 333 can be a set of fully-observed units at a given time t. The index-set 333 can be referred to as the “risk set.” The index-set 333 can include the set of units at risk 331 with unobserved units (i.e., those for which the time since the previous outage is unknown) removed (240).

A semiparametric model 370 can include a parametric component and a nonparametric component. The parametric component can be estimated (250) with a parametric estimator 340. The nonparametric component can be estimated (270) with a nonparametric estimator 350. In some embodiments, the parametric component can first be estimated as zero (255) at all times for which no event occurs (i.e., the “nothing” times in “all-or-nothing” treatment). Thus, conditioning on the failure times, the nonparametric component can be canceled out because it affects all units equally. The parametric component can then be conveniently estimated. After estimation of the parametric component, the nonparametric component can be estimated by a weighted nonparametric estimator, which can use the estimate of the nonparametric component. For example, the weighted nonparametric estimator can be the weighted non-parametric Nelson-Aalen estimator disclosed in J. Kalbfieisch and R. Prentice, The Statistical Analysis of Failure Time Data, Wiley-Interscience (2002). In some embodiments, the nonparametric component can be estimated as a constant for each physical system using a fitting process, described in more detail below.

In one embodiment, the semiparametric model can be given by

λ(t;i)=λ₀(t)ψ(t−τ_{i,l}), (9)

where the nonparametric component is given by λ₀(t), the parametric component is given by ψ(t)=e^{φ(t)}, j is a unit in the physical system under observation at time t, i(t) is the unit to fail at time t, t is the time of treatment, and [symbol] (t) is the index-set. The full likelihood of failure can thus be given by

$$l ( {λ}_{0} ( \cdot ) , ψ ( \cdot ) ) = ( {\prod }_{t ∈ T} {λ}_{0} ( t ) ψ ( t - {τ}_{t , i ( t )} ) ) \times {e}^{- {\int }_{0}^{T} {\sum }_{j ∈ ℛ ( t )} {λ}_{0} ( t ) ψ ( t - {τ}_{t , i ( t )} ) d t} . \qquad ( 10 )$$

λ₀(t) can first be estimated as zero at all times t is not in a set of finite times at which a failure event occurs. Thus, the λ₀ cancels out and allows for convenient estimation of ψ(t)=e^{φ(t)}. After the estimation of ψ(t), the λ₀ component can be estimated by a weighted nonparametric estimator, which can use the estimate of ψ(t), where λ₀ can be assumed to be constant within each physical system, the constant derived using the method of moments. For example, after estimating ψ(t), the reliability function can be given by

$$R ( t ) = {e}^{- {\int }_{0}^{t} h ( t )} = {e}^{- {λ}_{0} {\int }_{0}^{t} ψ ( u ) d u} , \qquad ( 11 )$$

from which the mean time to failure can be computed directly by layered representation of the expectation, which can follow from integration by parts:

$${E}_{{λ}_{0}} [ T ] = {\int }_{0}^{∞} {e}^{- {λ}_{0} {\int }_{0}^{u} ψ ( u ) d u} d t \qquad ( 12 )$$

At this point, λ₀ can be chosen by grid search over numeric approximations of the integral of equation 4, so that the mean time to failure equals the empirical mean time to failure E_{λ}_{₀}[T]= T̅.

In some embodiments, and again with reference to FIG. 2 and FIG. 3, a smoothing process (260) can be applied to the parametric component. The smoothing process can include a smoother 360 which can cause the processor 320 to execute a set of instructions to smooth the parametric component. For example, the smoothing process can be a Gaussian process applied to a portion of the parametric component without radial basis by marginalizing a portion of the parametric component onto a set of times. In one embodiment, the Gaussian process can be applied to values of φ(t) having a radial basis by marginalizing φ(t) onto tεT, thereby being normally distributed with a mean of 0 and a covariance matrix K with K=K_{i,l′}=ae^{-(i-l′)}^{²}^{/b}, where a is the marginal variance and b is the characteristic time scale. For example, the parameter values can be a=5, b=1e3. Alternatively, in some embodiments, cross-validation on a grid search on these parameters can be used to obtain appropriate estimates of a and b.

Fitting the Gaussian process can include, for example, applying the Newton-Raphson method to find a maximum a-posteriori estimate. The log-posterior probability can be proportional to the sum of the log and the Cox likelihood (l), given by equation 10, and the log of the marginalized Gaussian process marginal prior distribution (π):

$$\frac{\partial L}{\partial {λ}_{0} ( s )} = l + π = {\sum }_{t} log φ ( t - {τ}_{t , i} ) - log {\sum }_{j ∈ ℛ ( t )} φ ( t - {τ}_{i , j} ) + ( - 1 / 2 {φ}^{T} {K}^{- 1} φ ) \qquad ( 13 )$$

The gradient with respect to φ can be

$$∇ ( l + π ) = {\sum }_{t} \frac{- ψ ( t - {τ}_{i , t} ) + {e}_{i ( t )} {s}_{t}}{{s}_{t}} + {K}^{- 1} φ \qquad ( 14 )$$

with Hessian

$$\begin{matrix}{( ∇ ∇ ( l + π ) )}_{i , j} = ψ ( t - {τ}_{i , t} ) ψ ( t - {τ}_{j , i} ) / {s}_{t}^{3} + {K}^{- 1} \\ where & ( 15 ) \\ {s}_{t} = {\sum }_{j} ψ ( t - {τ}_{j , t} ) , & ( 16 )\end{matrix}$$

the total hazard of observed units at time t, and eᵢ₍ₜ₎ is the unit basis vector indicating the failed unit at time t, δᵢ₍ₜ₎. The step size can be dynamically adjusted, and can be stopped on a relative improvement of the quasi-posterior probability of less than 1.4e-08.

After the nonparametric component is estimated (270) with the nonparametric estimator 350 and the parametric component is estimated (250) with the parametric estimator 340, the hazard rate can be predicted (280) at a given time with reference to the semiparametric model 370. For example, where the semiparametric model 270 is given by equation 1, the hazard rate at a time t can be predicted by multiplying the value of the parametric component at time t by the value of the nonparametric component at time t. The processor 230 can be instructed to execute a series of commands to generate a prediction at one or more times. The system can include an output 380 for outputting the hazard rate prediction.

A computer system for practicing the method according to the presently disclosed subject matter can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store an executable computer program having instructions for controlling one or more computers.

### Example

The present application is further described by means of the examples, presented below. The use of such examples is illustrative only and in no way limits the scope and meaning of the invention or of any exemplified term. Likewise, this application is not limited to any particular preferred embodiments described herein. Indeed, many modifications and variations of the invention will be apparent to those skilled in the art upon reading this specification. The invention is to be understood by the terms of the appended claims along with the full scope of equivalents to which the claims are entitled.

The techniques of the presently disclosed subject matter were applied to power feeders in three boroughs of New York City (Manhattan, Queens, and Brooklyn). Distribution feeders are power cables that feed intermediate voltage power in distribution grids. In New York City, underground distribution feeders, which can be 27 KV or 13 KV, can be failure-prone electrical components in the power grid, particularly with respect to infant mortality.

Data for 81 units (N=81) was obtained. 667 distinct failures (T=667) were observed among the 81 units. Values of t−τ_{l,i} were binned into percentiles to achieve further reduction of data for numerical stability and to expedite cross-validation.

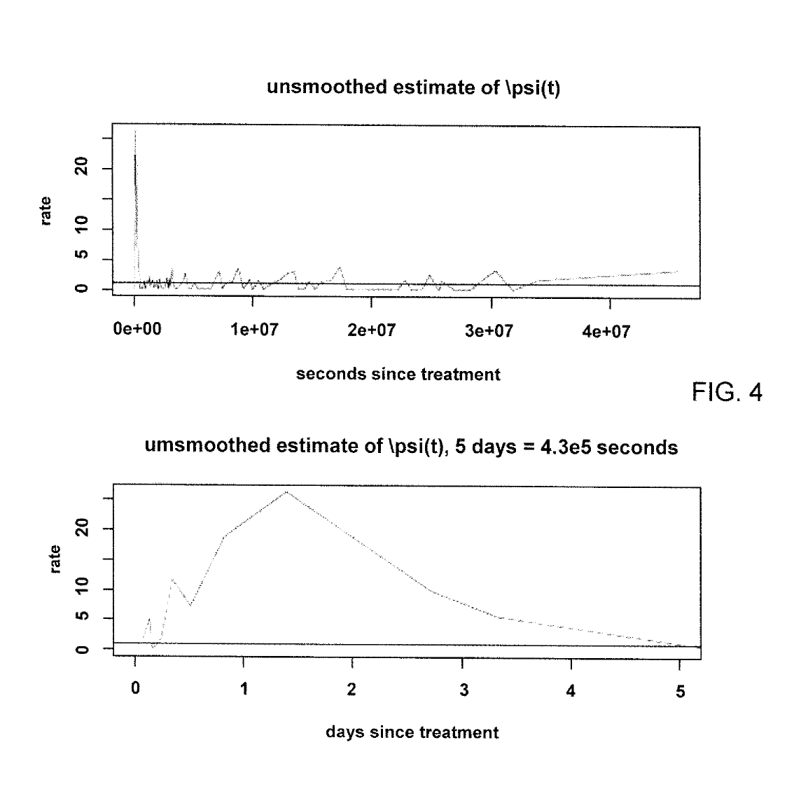

The model predictions without smoothing are provided in FIG. 4. As demonstrated by FIG. 4, the results are over-fitted to the data. Since events can occur rarely, such that some t−τ_{l,i}-bins can be observed only once, associated with a failure, causing a direct estimate of ψ(•) to overestimate. Likewise, many bins can be associated only with the non-failed risk set, and ψ(•) can go to zero. This effect can be more pronounced with a larger number of units and rare failures.

A Gaussian process prior was applied to the values of φ(t) with radial basis. After the standard marginalizing of the prior onto tεT, the φ(t) can be normally distributed with mean 0 and covariance matrix K with K_{i,l′}=ae^{-(t-l)}^{²}^{/b}. As noted above, this marginal prior distribution can be referred to as π, where parameters a, b are the marginal variance and so-called “characteristic time-scale” respectively. In the present example, parameter values a=5 and b=1e3 were used. However, in other embodiments, cross-validation on a grid search on these parameters can be used to obtain approximate “point estimates” of a, b.

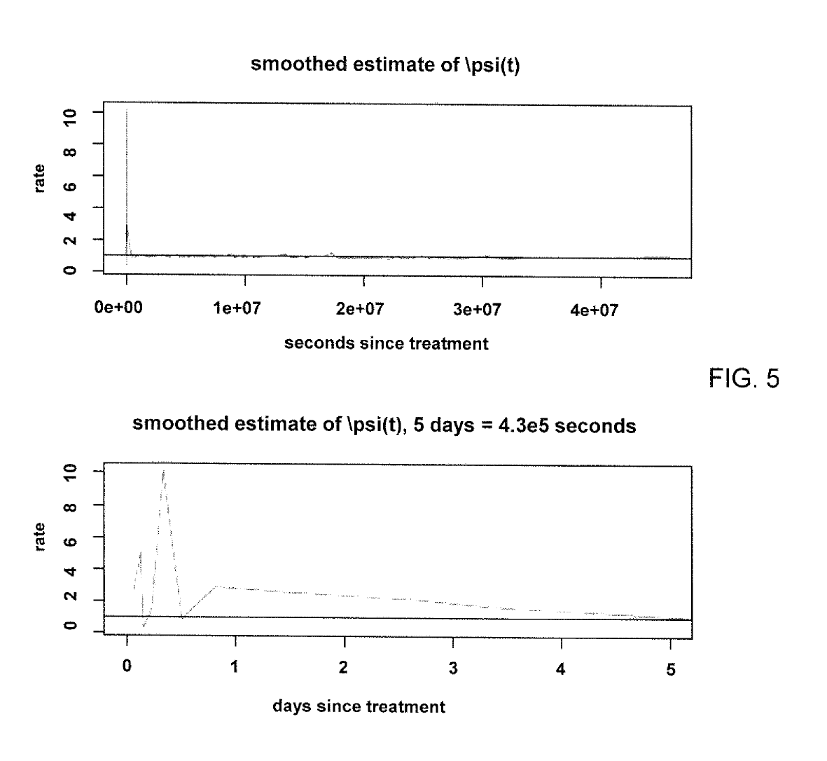

The Gaussian process was fit according to the process that follows: The log-posterior probability can be proportional to the sum of the log and the Cox likelihood (l), given by equation 10, and the log of the marginalized Gaussian process prior (π) given in equation 13. The Newton-Raphson method was applied to find the maximum a-posteriori estimate. The gradient with respect to φ was given by equation 14 and the Hessian given by equation 15. The step size was dynamically adjusted, and stopped on a relative improvement of the quasi-posterior probability of less than 1.4e-08. FIG. 5 depicts the results smoothed using the Gaussian process prior.

The semiparametric model with Gaussian smoothing was applied to five years of power feeder failure data collected in New York City. The estimation according to the techniques of the presently disclosed subject matter was compared with what actually happened, as well as the exponential distribution and Weibull distribution models.

In New York City, power feeder failure rates can be seasonal. For example, during summer heat waves, more power feeder failures can be likely. According to the present Example, three groups of estimates were provided for the summer, winter, and the whole year, given historical data for the first three years. These estimates were then compared to the actual failure rates measured for the last two years using the failure data.

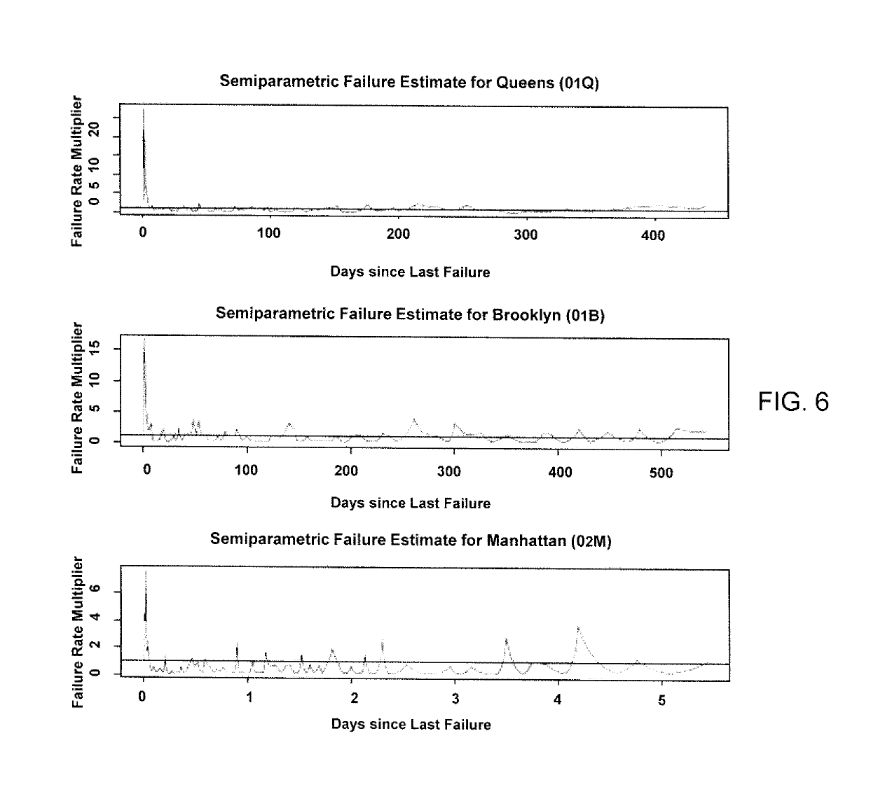

The results of fitting the model are summarized in Table 1 and FIG. 6 for each network.

TABLE 1

| Network | # of Units | # of Failures | Exponential λ |
|---|---|---|---|
| Queens: 01Q | 26 | 327 | 75.2 |
| Brooklyn: 01B | 29 | 197 | 154.12 |
| Manhattan: 02M | 26 | 143 | 114.1 |

| Network | Weibull k | Weibull λ | Semiparametric λ₀ |
|---|---|---|---|
| Queens: 01Q | 0.48 | 42 | 71.0 |
| Brooklyn: 01B | 0.69 | 120.4 | 130.0 |
| Manhattan: 02M | 0.62 | 108.0 | 112.1 |

The hazard estimates were integrated (numerically in the case of the semiparametric model) to convert the hazard estimates to estimates of the cumulative distribution function. The resulting model fits were then visually and numerically compared to the empirical distribution function of the data.

The fit of each model was evaluated on the training sets (i.e., the first three years) and the test sets (i.e., the last two years) using the Kolmogorov-Smirnoff (K-S) statistic, disclosed in R. H. C. Lopes, I. Reid, and P. R. Hobson, The two-dimensional Kolmogorov-Smirnov test, XI International Workshop on Advanced Computing and Analysis Techniques in Physics Research, Amsterdam, April 2007. The K-S statistic is a distance between the empirical distribution of the cumulative distribution function F, \hat{F}ₑₘₚ, and the F provided by each model fit. Since none of the models are to be considered true, the statistic can be used simply as a “measure of fit” on training and holdout data, rather as a formal hypothesis test. The empirical distribution can be defined as

$${\hat{F}}_{emp} ( t ) = \frac{1}{T} \sum {I}_{{t}_{i} < i} , \qquad ( 17 )$$

with the sum being over all inter-arrival times in the data. The K-S statistic is the maximum absolute discrepancy between the two distributions, defined as

$$KS ( {\hat{F}}_{emp} , F ) = {sup}_{l} \vert {\hat{F}}_{emp} ( t ) - {F}_{model} ( t ) \vert . \qquad ( 18 )$$

Table 2 summarizes the K-S test of fit.

TABLE 2

| | | | |
|---|---|---|---|
| Network | Exponential | Weibull | Semiparametric |

Training

| | | | |
|---|---|---|---|
| Queens: 01Q | 0.4 | 0.19 | 0.13 |
| Brooklyn: 01B | 0.25 | 0.17 | 0.14 |
| Manhattan: 02M | 0.27 | 0.17 | 0.12 |

Testing

| | | | |
|---|---|---|---|
| Queens: 01Q | 0.35 | 0.23 | 0.20 |
| Brooklyn: 01B | 0.27 | 0.20 | 0.16 |
| Manhattan: 02M | 0.38 | 0.31 | 0.32 |

Ad demonstrated by Table 2, the comparison of the estimation results illustrates that the failure rate estimates using the semiparametric model are closer to the actual measured inter-arrival times.

The presently disclosed subject matter is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

1. A method of predicting a metric of a physical system using a semiparametric model, comprising:
providing raw data representative of the physical system;
processing the raw data to identify a set of units at risk in the physical system, a set of times of treatment corresponding to a event of at least one unit in the set of units, and an index-set of the at least one unit for which a event has occurred;
estimating a nonparametric component of the semiparametric model with reference to the set of units, the set of times, and the index-set; and
predicting a hazard rate at a given time with the semiparametric model.

2. The method of claim 1, further comprising estimating a parametric component of the semiparametric model with reference to the set of units, the set of times, and the index-set.

3. The method of claim 1, wherein the event is a failure event.

4. The method of claim 1, wherein the metric is a failure metric.

5. The method of claim 1, wherein the metric comprises a mean time between failures.

6. The method of claim 1, further comprising storing the set of units, the set of times of treatment, and the index-set.

7. The method of claim 1, wherein providing raw data further comprises providing raw data in real time.

8. The method of claim 1, wherein the physical system is a cyber-physical system.

9. The method of claim 1, wherein the physical system is an electrical grid.

10. The method of claim 1, wherein the raw data represents an outage database.

11. The method of claim 1, wherein each treatment in the set of times of treatment comprises a single “all-or-nothing” treatment occurring at a recorded time.

12. The method of claim 2, further comprising:
estimating the nonparametric component as zero for all times except those included in the set of times of treatment and estimating the parametric component; and
estimating the nonparametric component using a weighted nonparametric estimator using a the estimate of the parametric component.

13. The method of claim 1, further comprising:
removing from the index-set units for which the times at which a event occurs is unknown or for which the treatment is unknown.

14. The method of claim 1, further comprising smoothing the nonparametric component with a smoothing process.

15. The method of claim 14, wherein the smoothing process is a Gaussian smoothing process.

16. The method of claim 2, wherein the nonparametric component is given by λ₀(t), the parametric component is given by ψ(t)=^{φ(t)}, the hazard rate is predicted with reference to the semiparametric model given by λ(t;i)=λ₀(t)ψ(t−τ_{l,i}), and a full likelihood of failure is given by
$$l ( {λ}_{0} ( \cdot ) , ψ ( \cdot ) ) = ( {\prod }_{t ∈ t} {λ}_{0} ( t ) ψ ( t - {τ}_{i , t ( t )} ) ) \times {e}^{- {\int }_{0}^{T} {\sum }_{j ∈ ℛ ( t )} {λ}_{0} ( t ) ψ ( t - {τ}_{t , i ( t )} ) d t} ,$$
where j is a unit in the physical system under observation at time t, i(t) is the unit to fail at time t, t is the time of treatment, and [symbol] (t) is the index-set.

17. The method of claim 16, wherein the Gaussian process is applied to values of φ(t) having a radial basis by marginalizing φ(t) onto tεT, thereby being normally distributed with a mean of 0 and a covariance matrix K with K_{l,l′}=ae^{-(l-i′)}^{²}^{/b}, where a is the marginal variance and b is the characteristic time scale.

18. A system for predicting a metric of a physical system using a semiparametric model and raw data representative of the physical system, comprising:
at least one processor, for processing the raw data to identify a set of units at risk in the physical system, a set of times of treatment corresponding to a event of at least one unit in the set of units, and an index-set of the at least one unit for which a event has occurred;
a nonparametric estimator configured to estimate a nonparametric component of the semiparametric model with reference to the set of units, set of times of treatment, and the index-set; and
at least one output for outputting a predicted hazard rate at a given time with the semiparametric model.

19. The system of claim 18, further comprising a parametric estimator configured to estimate a parametric component of the semiparametric model with reference to the set of units, set of times of treatment, and index set.

20. The system of claim 19, wherein the parametric estimator comprises a computer program stored in a non-transitory computer readable storage medium which when executed causes the at least one processor to estimate the parametric component of the semiparametric model.

21. The system of claim 18, further comprising at least one memory, operatively coupled to the at least one processor, for storing the set of units, the set of times of treatment, and the index-set.

22. The system of claim 18, wherein the nonparametric estimator comprises a computer program stored in a non-transitory computer readable storage medium which when executed causes the at least one processor to estimate the nonparametric component of the semiparametric model.

23. The system of claim 18, wherein the physical system is an electrical grid.

24. The system of claim 18, wherein the physical system is a cyber-physical system.

25. The system of claim 18, wherein the raw data assembly comprises an outage database.

26. The system of claim 18, further comprising a smoother, operatively coupled to the at least one process, for smoothing the nonparametric component with a smoothing process.

27. The system of claim 26, wherein the smoother comprises a Gaussian smoother.

28. The system of claim 18, wherein the processor is configured to process raw data on-line.
